(19) United States
(12) Patent Application Publication
(10) Pub. No.: US 2002/0007234 A1
(43) Pub. Date: Jan. 17, 2002

(54) Apparatus and method for transitioning from a dual air/ground and ground/ground aeronautical data network architecture to an end-to-end aeronautical data network architecture

(76) Inventors: Stephen B. Heppe, Purcellville, VA (US); K. Prasad Nair, Bethesda, MD (US); Steven Friedman, Silver Spring, MD (US)

Correspondence Address: BLANK ROME COMISKY & MCCAULEY LLP, THE FARRAGUT BUILDING SUITE 1000, 900 17TH STREET NW, WASHINGTON, DC, 20006, US

(21) Appl. No.: 09/848,539

(22) Filed: May 4, 2001

Related U.S. Application Data
(60) Provisional application No. 60/202,118, filed on May 5, 2000.

(51) Int. Cl. G06F 17/00

(52) U.S. Cl. 701/10; 701/3

(57) ABSTRACT

A time-phased deployment and implementation method for a new end-to-end network architecture intended to support data communications between customer aircraft and customer ground facilities. The time-phased deployment and implementation method allows graceful upgrade of services by customers, reduces technical and operational risk associated with new services, and enables cost-saving features such as network emulation and store-and-forward capability which would not otherwise be available. In one embodiment, the present invention enhances overall quality of service by allowing operation in either of two service provider networks depending on network availability.

### REFERENCE TO RELATED APPLICATION

The present application claims the benefit of U.S. Provisional Application No. 60/202,118, filed May 5, 2001, whose disclosure is hereby incorporated by reference in its entirety into the present disclosure.

### FIELD OF THE INVENTION

The present invention is directed to the cost-effective implementation of new end-to-end networking architectures for communications between customer aircraft and customer ground facilities.

### BACKGROUND OF THE INVENTION

Commercial aircraft commonly transmit and receive air/ground digital information via radio equipment operating in the Very High Frequency (VHF) portion of the radio spectrum, on 25 kHz channels, using a system known generically as the Aircraft Communications Addressing and Reporting System (ACARS). There are several variations of ACARS in use today, including extensions to satellite relay media and High Frequency (HF) radio. Communications services using these systems are provided to customers by commercial enterprises on a for-fee basis, using networks of fixed ground stations (and optionally satellites) which support compatible protocols and hardware. The airborne equipment, ground station equipment and extended ground network all cooperate to support the end-to-end transmission and reception of digital information between a customer's aeronautical mobile station (an aircraft) and ground-based end-system (e.g., an airline operations center). In the currently-deployed and operational systems, onboard end-system equipment (e.g., an FMC or printer) communicates individually with an ACARS Management Unit (MU) according to the rules of ARINC Specification 619. The ACARS MU acts as an application gateway between these onboard systems and the air/ground network which includes the RF link and extends to a service-provider application gateway. The ground/ground data exchange between a service-provider application gateway and a customer-premises application gateway is viewed as comprising a separate network with different and incompatible protocols relative to the air/ground network. It is the responsibility of the service provider to manage the air/ground exchange of data and provide routing and protocol conversions as needed to interface with the intended users' ground-based end-systems. The ACARS air/ground environment is described in ARINC Specification 618. The capabilities of onboard equipment are defined in ARINC Characteristics 597, 724 and 724B. The ACARS ground/ground environment is described in ARINC Specification 620. The routing and protocol conversion functions are provided in one or more application gateway(s) maintained by the service provider(s). The(se) application gateway(s) represent critical points of failure, and must be highly reliable in order to ensure the desired quality of service.

In the currently-deployed and operational systems, both the air/ground protocol (e.g., ARINC 618) and the ground/ground protocol (e.g., ARINC 620) require significant tailoring on a per-customer basis (i.e., some messages are airline-specific and so must be interpreted differently for each airline), a per-aircraft basis (different aircraft operated by the same airline may support different equipment which requires special protocol conversions on the air or on the ground), and sometimes even a location basis (some destination addresses must be decoded differently based on the current location of the aircraft). This leads to a complex service provider application gateway. Therefore, another consequence of the known system is ongoing protocol tailoring which in turn leads to high maintenance cost, and can also impair overall network performance (many failures are attributed to software error).

The aviation community has developed a new networking standard, known as the Aeronautical Telecommunications Network (ATN), which replaces the entire current system with new avionics and ground equipment providing end-to-end routing without need for protocol conversion by the service provider. This enhances ground network reliability but requires all new hardware on customer aircraft and at customer ground sites. The transition, from the current system architecture comprising two incompatible networks to the future system architecture comprising a single end-to-end network, is planned to occur in several stages comprising:

a) transition to a new air/ground radio subnetwork with higher throughput than is currently available (the air/ground network protocols will be modified slightly but the dualnetwork architecture will remain substantially unchanged);

b) service providers will install appropriate ground equipment and networks to support the ATN, said ground equipment and networks capable of operating in parallel with existing services;

c) eventually, the application gateways on customer aircraft and at customer-premises ground facilities will be replaced or modified to support the ATN.

In FIG. 1, the current air/ground networking architecture is illustrated. Consider a downlink message i.e. one generated by an aircraft 11 intended for delivery to a customerpremise end system 20 on the ground. The message may be generated with our without human intervention by onboard equipment 12 or the application gateway 13, for example an ACARS Management Unit (MU). The aircraft application gateway 13 is part of the air/ground communications network 15 which typically implements a standardized set of protocols tailored for RF communications between the airborne radio equipment 14 and the ground station radio equipment 16. The set of protocols would typically comprise physical, link layer and subnetwork layer protocols for RF communications between airborne radio 14 and ground radio 16, and network layer protocols for data communications between the airborne application gateway 13 and the service provider's application gateway 17. The network access points for the air/ground network 15 are the airborne application gateway 13 and the service provider's application gateway 17. One example of a network layer protocol is the ARINC Specification 618 which implements ACARS.

The user's message information is passed through the radio equipment 14, the ground station 16, and thence to the service provider's application gateway 17, for example AFEPS in the ARINC ACARS network. The detailed formatting of the message may depend on aircraft ID and ground station location, as noted above, but must conform with the protocol standard for the air/ground network as a whole (for example, ARINC Specification 618). Several message interchanges may exist between each pair of hardware elements, and the path between the ground station 16 and the application gateway 17 may traverse many networking nodes, but the important feature is that information encoded in the air/ground networking protocol standard (e.g., ARINC Specification 618) is only decoded and processed at the application gateway 17.

After reading the downlink message and understanding its source and intended destination, the application gateway 17 reformats the message to comply with a separate ground/ground networking protocol (for example, ARINC Specification 620) and delivers the message through a ground/ground network 18 to the intended destination customer premises application gateway 19 (which may then pass the information to other customer equipment 20). Again, the path from the service provider's application gateway 17 to the customer premises application gateway 19 could traverse many networking nodes and several messages may be exchanged on each leg of the path. The network access points for the ground/ground network 18 are the service provider's application gateway 17 and the customer premises application gateway 19.

Uplink information passes from ground-based customer equipment to an aircraft by following a path substantially in reverse order to that described for a downlink message.

The principle feature of the present system is that an application gateway provides the interface between the air/ground network 15 and the ground/ground network 18. The service provider's application gateway cannot be bypassed since, for example, the source and destination information used on the air/ground network 15 is not able to be interpreted by the protocol elements of the ground/ground network 18.

The ATN provides a single network without any need for the service provider to maintain an application gateway, but requires the replacement of the airborne application gateway 13 and the customer premises application gateway 19. The aviation industry is currently planning to transition to the ATN in several phases comprising: a) introduction of new air/ground radios in customer aircraft and in service provider ground stations, with a modification of the air/ground data link and subnetwork layer protocols to allow effective continuation of the existing overall networking architecture; b) introduction of ATN-compliant ground systems at the service provider(s) facilities and customer premises facilities; and c) eventual replacement of airborne application gateway functionality with ATN-compliant finctionality (this may also involve minor consequential changes to the interfaces to the airborne radios). This transition plan delays the introduction into use of an end-to-end networking architecture and maintains reliance on the service-provider application gateway(s) on the ground.

### SUMMARY OF THE INVENTION

This invention is a time-phased deployment and implementation method for a new endto-end network architecture intended to support data communications between customer aircraft and customer ground facilities. The time-phased deployment and implementation method allows graceful upgrade of services by customers, reduces technical and operational risk associated with new services, and enables cost-saving features such as network emulation and store-and-forward capability which would not otherwise be available. In one embodiment, the present invention enhances overall quality of service by allowing operation in either of two service provider networks depending on network availability.

### BRIEF DESCRIPTION OF THE DRAWINGS

FIG. 1 illustrates a conceptual view of the existing air/ground network architecture.

FIG. 2 illustrates a conceptual view of an intermediate stage in the transition from the existing air/ground network architecture to a future air/ground network architecture according to the present invention.

FIG. 3 illustrates a conceptual view of a final stage in the transition from the existing air/ground network architecture to a future air/ground network architecture according to the present invention.

FIG. 4 illustrates a detail for one embodiment of the present invention during the second intermediate phase of transition.

### DETAILED DESCRIPTION OF THE INVENTION

Preferred embodiments of the present invention will be disclosed with reference to FIGS. 2-4.

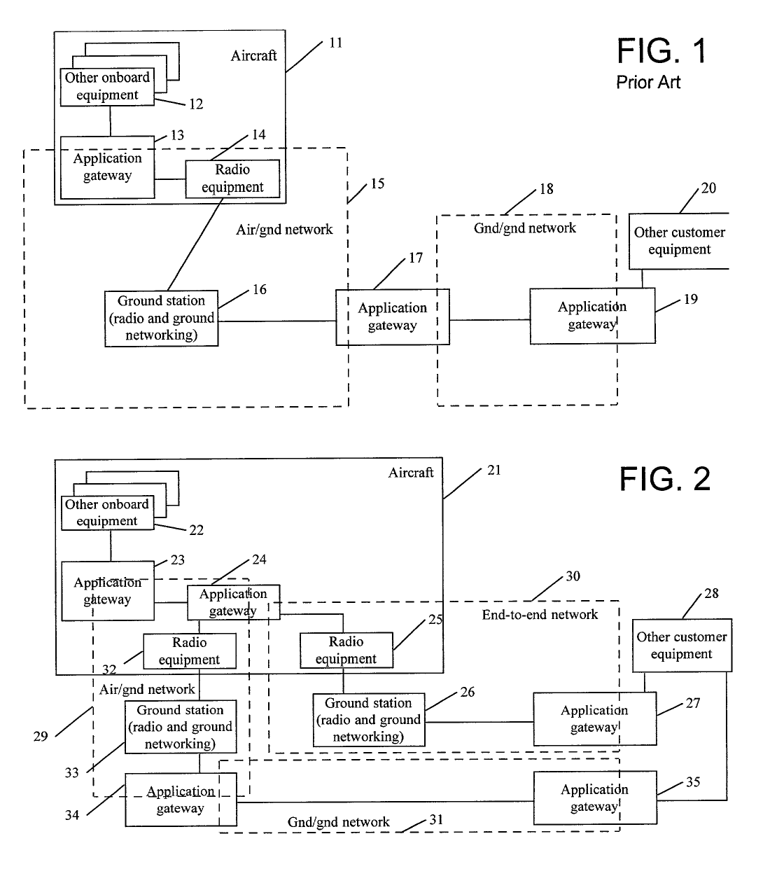

FIG. 2 illustrates a conceptual view of a network architecture associated with an intermediate stage of transition according to the present invention. The aircraft equipment includes a legacy application gateway 23 which may be the same as the present system application gateway 13 illustrated in FIG. 1, and a new additional application gateway 24 which comprises the finctions of customer-specific protocol conversion and routing functionality for the end-to-end network 30. The onboard radio 25 and ground station 26 may be legacy systems or new systems, or may comprise a mixture of new and old systems. If the onboard radio equipment 25 is new equipment which does not interoperate with the present system, then in this intermediate stage of transition the customer aircraft maintains legacy radio equipment 32 which interoperates with the present system ground station 33. However, in a preferred embodiment the new application gateway 24, new radio equipment 25 and legacy radio equipment functionality (equivalent to the capability represented by the legacy radio equipment 32) are provided in a single chassis which connects to the legacy application gateway 23 and also an antenna for RF communication with suitable ground stations 26 (for the new end-to-end network 30) and 33 (for the old air/ground network 29). One of the functions of the application gateway 24 is to monitor the availability of RF communications to suitable ground stations 33 in the present air/ground network 29, and suitable ground stations 26 the new end-to-end network 30. This monitoring function may rely on various messages transmitted by the ground stations 33 and 26 and received by the radio equipment 32 (or its equivalent functionality) and the radio equipment 25, respectively, and may also rely on link and subnetwork setup and maintenance status associated with the respective protocol state machines.

When the aircraft 21 is operating in a region supported only by the present system (represented by the air/ground network 29 and the ground/ground network 31), downlink information is passed from the legacy application gateway 23 to the new application gateway 24, then to the legacy radio equipment 32 (or the equivalent radio equipment functionality), then to the ground station 33, the service-provider application gateway 34, and the customer-premises application gateway 35 (where it may be routed as needed according to customer requirements). Information is encoded using the protocols of the present system air/ground network 29 and the present system ground/ground network 31 with the service provider application gateway 34 providing protocol conversion and routing functionality. Uplink information from the customer ground facility is routed along a path essentially in reverse order. For both uplink and downlink information exchange, multiple data packets may be exchanged in each direction on each link of the network path and each link between pairs of hardware elements may operate with different physical, link layer and subnetwork layer protocols.

When the aircraft 21 is operating in a region supported by the new end-to-end network 30 (including appropriate ground station facilities 26), downlink information is passed from the legacy application gateway 23 to the new application gateway 24, then to the new radio equipment 25, then to the ground station 26, and the customer-premises application gateway 27 (where it may be routed as needed according to customer requirements). Information is encoded using the protocols of the new end-to-end network 30 with the new airborne application gateway 24 providing protocol conversion and routing functionality. Uplink information from the customer ground facility is routed along a path essentially in reverse order. For both uplink and downlink information exchange, multiple data packets may be exchanged in each direction on each link of the network path and each link between pairs of hardware elements may operate with different physical, link layer and subnetwork layer protocols. In this mode of operation, the air/ground network of the present system may be considered to exist in a virtual sense comprising selected protocol elements in the legacy application gateway 23, the new application gateway 24, and the signal path(s) between them.

When the aircraft 21 is operating in a region where neither the present system nor the new system is available, real-time communications between the aircraft and the customer ground facility are unavailable. However, since the new application gateway 24 is capable of emulating the air/ground network functionality of the application gateway 34 (equivalent to the present system application gateway 17 of FIG. 1), an enhanced store-and-forward capability exists at this stage of the transition (although the storage node is still on the customer's aircraft). Downlink messages can be “delivered” from the legacy application gateway 23 to the new application gateway 24 and held pursuant to predefined customer-specific policy guidelines until a suitable downlink opportunity exists via the new end-to-end network 30. This store-and-forward capability may also be used when an aircraft 21 is operating in a region that supports the present system (represented by the air/ground network 29 and the ground/ground network 31), and said region does not support the new end-to-end network 30. This store-and-forward may enable a reduction in cockpit workload and may be beneficial, for example, when communicating data which is not time critical if there is a significant cost disparity between the present system and the new end-to-end system.

In a variant of the present invention, the new application gateway 24 supports data protocols to allow direct interworking with selected onboard equipment 22 (e.g., in accordance with ARINC Specification 619) allowing the legacy application gateway 23 to be bypassed or removed (i.e., if all onboard equipment currently connected to the legacy application gateway 23 is re-routed to connect with the new application gateway 24).

In another variant of the present invention, the customer-premises application gateways 27 and 35 are realized in a single computer with multiple ports allowing connection to the present system ground/ground network 31 and also the new end-to-end network 30.

In a preferred embodiment of the present invention, the RF link between airborne radio equipment 25 and ground station 26 relies on physical, link layer and subnetwork layer protocols defined by draft ICAO-standard VHF Data Link Mode 4. Subnetwork control information, transmitted by radio stations compliant with this protocol, allows the geographic tracking of aircraft. This information can be delivered as auxiliary data to the customer ground facility in order to support flight following, and also to allow the more efficient scheduling and routing of uplink communications. Furthermore, if this information is made available to the new application gateway 24, in conjunction with data base information describing known coverage of available networks, the new application gateway can make routing decisions based on imminent network availability (i.e., due to the projected flight plan of the aircraft), as well as current network availability.

Uplink information passes from ground-based customer equipment 28 to an aircraft 21 by following a path substantially in reverse order to that described for a downlink message.

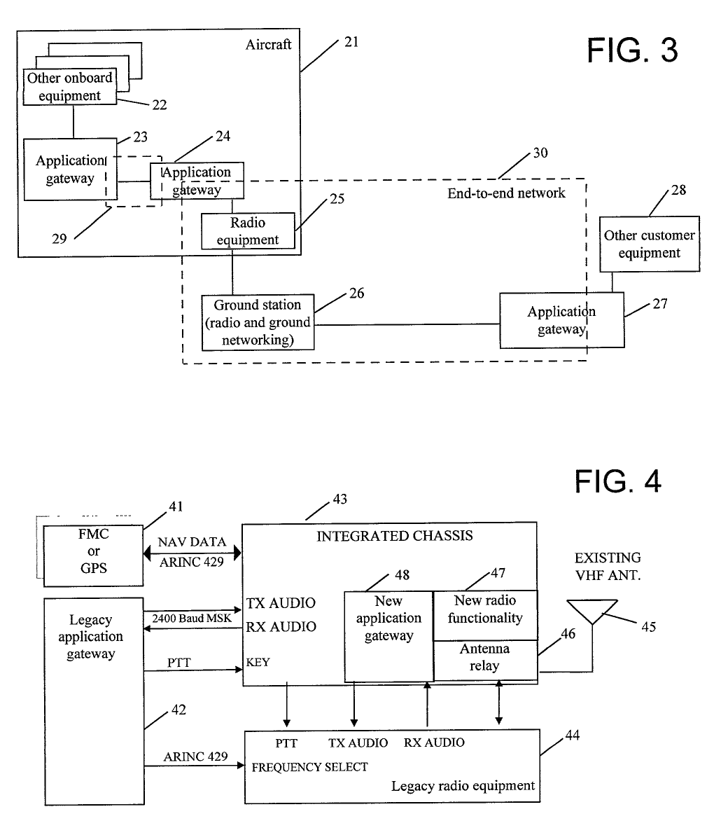

FIG. 3 illustrates a conceptual view of a network architecture associated with a final stage of transition according to the present invention. In this stage of transition, data communications are fully and solely supported by the new end-to-end network 30 and the associated airborne and ground-based elements. All elements of FIG. 3 are also contained in FIG. 2 and behave in a similar fashion, as described in relation to FIG. 2, in support of data communications by the new end-to-end network 30. However, certain elements of FIG. 2 have been deleted in the shift to a final stage of transition illustrated in FIG. 3 The deleted elements of FIG. 2 are those elements that were solely associated with the present system (i.e., legacy radio equipment 32, ground station 33, service provider application gateway 34, ground/ground network 31 and customer premises ground/ground network application gateway 35).

In a variant of the present invention, the transition is frozen for an indefinite period of time at the intermediate stage illustrated in FIG. 2 in order to preserve a residual or backup capability via the present system.

FIG. 4 illustrates a detail for one embodiment of the present invention during the second intermediate phase of transition wherein the new application gateway 48 and new radio equipment functionality 47 are housed in a single chassis 43. In this embodiment the legacy application gateway 42 (e.g. an ACARS MU) connects to the new application gateway 48 contained in chassis 43 via transmit (TX) and receive (RX) audio lines and a push-to-talk key signaling line. The legacy application gateway 42 also connects directly to the legacy radio equipment 44 for the purpose of frequency control tuning (this signal could be passed through the chassis 43, but this is not required). The chassis 43 is also connected to the legacy radio equipment 44 by TX/RX audio lines, PTT signal line and antenna. The chassis 43 is directconnected to an existing VHF antenna 45 and may optionally communicate with other onboard equipment such as an FMC or GPS receiver 41. The antenna relay 46 provides a fan-out from the existing VHF antenna to the legacy radio equipment 44 and the new radio equipment functionality 47 for the purpose of radio reception, and a hard switch from either the legacy radio equipment 44 or the new radio equipment functionality 47 to the existing VHF antenna 45 for the purpose of radio transmission. When the host aircraft is operating in a region with network support via the present air/ground network only, and real-time communications via this present air/ground network are desired, TX/RX audio and PTT signal indications are transparently passed between the legacy application gateway 42 and the legacy radio equipment 44, and the antenna relay 46 switches the legacy radio equipment 44 to the existing VHF antenna 45 for the purpose of radio transmission by the legacy radio equipment 44. However, if radio transmissions by the new radio equipment functionality 47 are required, transmissions by the legacy application gateway 42 and the legacy radio equipment 44 can be temporarily delayed by asserting the RX audio line in a manner to trigger the carrier detect function of the legacy application gateway 42. When the host aircraft is operating in a region with network support via the new end-to-end network, and real-time communications via this new end-to-end network are desired, the new application gateway 48 interoperates with legacy application gateway 42 via the TX/RX audio lines, performs the necessary protocol conversions, and interoperates with the new end-to-end network via the new radio equipment functionality 47. The new application gateway functionality 48 monitors RF reception from the legacy radio equipment 44 and the new radio equipment functionality 47. When operating in a region where both a legacy air/ground network and a new end-to-end network are available, communications can proceed by either path so described in accordance with policy guidelines defined by the customer. In a preferred embodiment, RX audio is asserted during periods of RF transmission by the new radio functionality 47, and immediately prior to such periods, in order to prevent simultaneous transmission attempts by the legacy application gateway 42.

When the PTT key line is asserted, the legacy radio equipment 44 has priority access to the VHF antenna 45 in order to support emergency voice operations.

One advantage of the present invention is the ability to support a more rapid transition to a full end-to-end network, compared to the transition plan for the present system. Information can be delivered at lower cost via the new end-to-end system since that system avoids the need for a service provider application gateway and hence has reduced costs.

A second advantage of the present invention is higher quality of service due to network availability via multiple networks.

A third advantage is that the present system capability is retained as a backup in the event of service failures associated with deployment of the new end-to-end system.

A fourth advantage of the present invention is that individual users may tailor their messages independently of one another and independently of the network service provider. This avoids errors due to unintentional user-to-user ambiguity, eliminates delays associated with service provider workload scheduling, and provides increased user flexibility.

A fifth advantage of the present invention is that users may upgrade their services incrementally, switching to a new network service provider (with a new application gateway 24, and possibly a new radio 25 which may be housed in the same chassis), while reusing existing avionics such as an ACARS MU.

A sixth advantage is a store-and-forward capability which may ease cockpit workload.

While various preferred embodiments of the present invention have been set forth above, those skilled in the art who have reviewed the present disclosure will readily appreciate that other embodiments can be realized within the scope of the invention. For example, communication protocols other than those disclosed can be used. Therefore, the present invention should be construed as limited only by the appended claims.

We claim:

1. A method for transitioning from a first data networking protocol using an air/ground network and a ground/ground network to a second data networking protocol using an end-to-end network, the method comprising:
(a) installing a new application gateway on an aircraft, the new application gateway emulating said air/ground network as perceived by onboard equipment on the aircraft and providing an application gateway for said ground/ground network while also providing a link between the onboard equipment and the end-to-end network, allowing said air/ground network and ground/ground network to be bypassed in favor of said end-to-end network; and
b) implementing a transition in first, second, and third stages, wherein the first stage uses the first air/ground network and ground/ground network, the second stage is a hybrid networking architecture wherein aeronautical air/ground data may be routed through the air/ground network and the ground/ground network or through the end-to-end network, and the third stage is a networking architecture characterized solely by use of the end-to-end network providing service from the aircraft to customer premises on the ground.

2. The method of claim 1, wherein connectivity to the air/ground network and ground/ground network is retained in the first, second and third stages in order to enhance service availability.

3. The method of claim 2, wherein messages are routed preferentially over the first air/ground network and ground/ground network, or the second end-to-end network, based on policy guidelines specified by a customer.

4. The method of claim 2, further comprising performing a store-and-forward technique, allowing delayed transmission of messages intended for the air/ground network via the end-toend network, in order to reduce measured usage of the first air/ground network and ground/ground network.

5. The method of claim 1, further comprising converting the new application gateway to interoperate with selected existing onboard equipment.

6. In a user's fleet of aircraft, a method for transitioning fleet operation from a first data networking architecture using an air/ground network and ground/ground network to a second data networking architecture using an end-to-end network, said method occurring over an extended period of time as individual aircraft are suitably equipped, said method comprising the steps of:
(a) installing application gateway and radio equipment on fleet aircraft allowing interoperation with either said first data networking architecture or said second data networking architecture;
(b) demonstrating operationally that the said second data networking architecture achieves desired performance, (c) adjusting policy guidelines for routing of traffic via said first data networking architecture or said second data networking architecture; and
(d) removing unneeded equipment associated with said first data networking architecture.
